(19) United States
(12) Patent Application Publication
(10) Pub. No.: US 2019/0331794 A1
(43) Pub. Date: Oct. 31, 2019

(54) Beamforming with coded signals in frequency domain

(71) Applicant: TECHNION RESEARCH & DEVELOPMENT FOUNDATION LTD., Haifa (IL)

(72) Inventors: Tanya Chernyakova, Haifa (IL); Yonina C. Eldar, Haifa (IL); Almog Lahav, Moshav Sde-Eliezer (IL); Yuval Ben-Shalom, Kibbutz Dan (IL)

(21) Appl. No.: 16/475,147

(22) PCT Filed: Dec. 11, 2017
(86) PCT No.: PCT/IB2017/057778

§ 371 Date: Jul. 1, 2019

Related U.S. Application Data
(60) Provisional application No. 62/441,464, filed on Jan. 2, 2017.

(51) Int. Cl. G01S 15/89; G01S 7/52; G10K 11/34

(52) U.S. Cl. CPC G01S 15/8915; G01S 15/8961; G10K 11/346; G01S 7/52047; G01S 7/52034

(57) ABSTRACT

A method includes receiving from multiple transducers (28) respective signals including reflections of a transmitted coded signal from a target. An image (42) of the target is produced by computing transducer-specific frequency-domain coefficients for each of the received signals, deriving, from the transducer-specific frequency-domain coefficients, beamforming frequency-domain coefficients of a beamformed signal in which (i) the reflections are applied pulse compression, and (it) the reflections received from a selected direction relative to the transducers are emphasized, and reconstructing the image of the target at the selected direction based on the beamforming frequency-domain coefficients.

### CROSS-REFERENCE TO RELATED APPLICATIONS

This application claims the benefit of U.S. Provisional Patent Application 62/441,464, filed Jan. 2, 2017, whose disclosure is incorporated herein by reference.

### FIELD OF THE INVENTION

The present invention relates generally to signal processing, and particularly to methods and systems for combined beamforming and coded signals processing in the frequency domain.

### BACKGROUND OF THE INVENTION

Beamforming is a spatial filtering technique that is used in a wide variety of fields and applications, such as wireless communication, ultrasound imaging and other medical imaging modalities, radar, sonar, radio-astronomy and seismology, among others. Beamforming techniques for ultrasound imaging are described, for example, by Steinberg, in “Digital Beamforming in Ultrasound,” IEEE Transactions on Ultrasonics, Ferroelectrics and Frequency Control, volume 39, number 6, 1992, pages 716-721.

Tur et al. describe efficient ultrasound signal sampling techniques, in “Innovation Rate Sampling of Pulse Streams with Application to Ultrasound Imaging,” IEEE Transactions on Signal Processing, volume 59, number 4, 2011, pages 1827-1842, which is incorporated herein by reference. Wagner et al. describe beamforming techniques applied to sub-Nyquist samples of received ultrasound signals, in “Compressed Beamforming in Ultrasound Imaging,” IEEE Transactions on Signal Processing, volume 60, number 9, September, 2012, pages 4643-4657, which is incorporated herein by reference.

Coded Excitation (CE) is a technique in which the transmitted signal comprises a modulated or coded signal so that at reception, pulse compression is achieved by correlating the received signal with the transmitted pulse. CE is described, for example, by Chiao and Hao, in “Coded excitation for diagnostic ultrasound: a system developer's perspective,” IEEE Transactions on Ultrasonics, Ferroelectrics, and Frequency Control, volume 2, number 52, February, 2005, pages 160-170.

### SUMMARY OF THE INVENTION

An embodiment that is described herein provides a method including receiving from multiple transducers respective signals including reflections of a transmitted coded signal from a target. An image of the target is produced by computing transducer-specific frequency-domain coefficients for each of the received signals, deriving, from the transducer-specific frequency-domain coefficients, beamforming frequency-domain coefficients of a beamformed signal in which (i) the reflections are applied pulse compression, and (ii) the reflections received from a selected direction relative to the transducers are emphasized, and reconstructing the image of the target at the selected direction based on the beamforming frequency-domain coefficients.

In some embodiments, the transmitted coded signal includes a signal modulated using a linear Frequency Modulation (FM) scheme. In other embodiments, deriving the beamforming frequency-domain coefficients includes computing the beamforming frequency-domain coefficients only within an effective bandwidth of the beamformed signal. In yet other embodiments, reconstructing the image includes applying an inverse Fourier transform to the beamforming frequency-domain coefficients.

In an embodiment, deriving the beamforming frequency-domain coefficients includes computing the beamforming frequency-domain coefficients only within a partial sub-band within an effective bandwidth of the beamformed signal. In another embodiment, reconstructing the image includes applying to the beamformed frequency-domain coefficients a recovery process selected from a list including (i) a Compressed Sensing (CS) process, (ii) a sparse recovery process, and (iii) a regularized recovery process. In yet another embodiment, reconstructing the image includes applying to the beamformed frequency-domain coefficients an algorithm for extracting sinusoids from a sum of sinusoids.

In some embodiments, reconstructing the image includes estimating the beamformed signal in time-domain based on the beamforming frequency-domain coefficients, and reconstructing the image from the estimated beamformed signal. In other embodiments, estimating the beamformed signal includes applying an l1-norm optimization to the beamforming frequency-domain coefficients. In yet other embodiments, deriving the beamforming frequency-domain coefficients includes computing a weighted average of the transducer-specific frequency-domain coefficients.

In an embodiment, computing the weighted average includes applying to the transducer-specific frequency-domain coefficients predefined weights that depend on the transmitted coded signal. In another embodiment, reconstructing the image of the target includes reconstructing both dominant reflections and speckle based on the beamforming frequency-domain coefficients. In yet another embodiment, computing the transducer-specific frequency-domain coefficients includes deriving the transducer-specific frequency-domain coefficients from sub-Nyquist samples of the received signals.

There is additionally provided, in accordance with an embodiment that is described herein, an apparatus that includes an input interface and processing circuitry. The input interface is configured to receive from multiple transducers respective signals including reflections of a transmitted coded signal from a target. The processing circuitry is configured to produce an image of the target, by computing transducer-specific frequency-domain coefficients for each of the received signals, deriving, from the transducer-specific frequency-domain coefficients, beamforming frequency-domain coefficients of a beamformed signal in which (i) the reflections are applied pulse compression, and (ii) the reflections received from a selected direction relative to the transducers are emphasized, and reconstructing the image of the target at the selected direction based on the beamforming frequency-domain coefficients.

There is also provided, in accordance with an embodiment that is described herein, a method including receiving from multiple transducers respective signals including reflections of a transmitted coded signal from a target. Transducer-specific frequency-domain coefficients are computed for each of the received signals. Beamforming frequency-domain coefficients of a beamformed signal in which (i) the reflections are applied pulse compression, and (ii) the reflections received from a selected direction relative to the transducers are emphasized, are derived from the transducer-specific frequency-domain coefficients. An image of the target at the selected direction is reconstructing based on the beamforming frequency-domain coefficients, under a constraint that the received signals are compressible.

There is further provided, in accordance with an embodiment that is described herein, an apparatus that includes an input interface and processing circuitry. The input interface is configured to receive from multiple transducers respective signals including reflections of a transmitted coded signal from a target. The processing circuitry is configured to compute transducer-specific frequency-domain coefficients for each of the received signals, to derive, from the transducer-specific frequency-domain coefficients, beamforming frequency-domain coefficients of a beamformed signal in which (i) the reflections are applied pulse compression, and (ii) the reflections received from a selected direction relative to the transducers are emphasized, and to reconstruct an image of the target at the selected direction based on the beamforming frequency-domain coefficients, under a constraint that the received signals are compressible.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an ultrasound imaging system, in accordance with an embodiment of the present invention;

FIG. 2 is a diagram showing the geometry of an array of ultrasound transducers, in accordance with an embodiment of the present invention;

FIG. 3 is a flow chart that schematically illustrates a method for Coded Excitation (CE) ultrasound imaging, in accordance with an embodiment of the present invention; and

FIG. 4 is a block diagram that schematically illustrates an ultrasound imaging system, in accordance with another embodiment of the present invention.

### DETAILED DESCRIPTION OF EMBODIMENTS

### Overview

Embodiments that are described herein provide improved methods and system for frequency-domain pulse compression and beamforming of received signals. Although the embodiments described herein refer mainly to pulse compression and beamforming in the context of ultrasound imaging, the disclosed techniques can be used in various other suitable applications that involve beamforming, such as other medical imaging modalities, wireless communication, radar, sonar, speech and other audio processing, radio-astronomy and seismology.

An ultrasound imaging system typically transmits ultrasound signals into target tissue using an array of ultrasound transducers, and then receives and processes the signals reflected from the tissue. Receive-side beamforming in such a system generally involves summing the received signal after delaying each signal by an appropriate delay, such that all the reflections from a desired direction and range align in time. In applying coded excitation techniques, the received signals are applied pulse compression before being delayed and summed. This process is typically repeated over multiple directions and ranges, so as to construct an ultrasound image that covers a sector of interest. Performing the receive-side beamforming computations in the time domain requires very high sampling rates and high computational complexity.

Excitation signals in ultrasound conventionally comprise a single-carrier Gaussian pulse. Transmitting a coded signal instead, and applying pulse compression at the receive side, have advantages such as improved Signal to Noise Ratio (SNR) and imaging depth.

Pulse compression may be performed by applying to the received signal a Matched Filter (MF) in accordance with the pulse-shape (defined as an amplitude vs. time function) of the transmitted coded signal. The MF effectively converts a stream of echoed pulses to a stream of respective ambiguity functions of the coded signal. Beamforming may then be applied to the signals output by the MFs. High-resolution Ultrasound imaging typically requires higher than Nyquist sampling rates. The addition of pulse compression per transducer in such systems is usually impractical.

In some embodiments of the present invention, an ultrasound imaging system performs receive-side pulse compression and beamforming in the frequency domain rather than in the time domain. The system computes Fourier coefficients for the coded signal received (uncompressed) via each transducer, and then derives the Fourier coefficients of the pulse-compressed and beamformed signal directly from the Fourier coefficients of the received coded signals. Only at this stage, the system reconstructs the time-domain beamformed signal from the Fourier coefficients of the pulse-compressed and beamformed signal. In the preset disclosure, beamforming is applied to the pulse-compressed versions of the received signals in a combined manner. The term “pulse-compressed and beamformed signal” is also referred herein to simply as “beamformed signal,” for brevity.

Various aspects of implementing beamforming in the frequency domain are described in U.S. Pat. No. 9,778,557, which is assigned to the assignee of the present patent application and whose disclosure is incorporated herein by reference.

In some embodiments, the system derives the Fourier coefficients of the pulse-compressed and beamformed signal by calculating a weighted sum of the Fourier coefficients of the received signals. The weights used in the summation depend on the direction of the received signal relative to the transducer array, and implicitly incorporate the pulse compression operation. Given the characteristic of the coded signal transmitted, these weights can be pre-calculated off-line. Since the weighting function decays rapidly, in most cases it is sufficient to sum over a small number of Fourier coefficients.

Performing combined pulse compression and beamforming operation in the frequency domain enables the system to use a very low sampling rate, while still producing high-quality images. In some embodiments, the Fourier coefficients are computed only within the effective bandwidth of the ambiguity function corresponding to the transmitted coded signal, and therefore can be derived from low-rate samples of the received signals. Further reduction in sampling rate is achievable by computing the Fourier coefficients for only a portion of the bandwidth of the corresponding ambiguity function. A linear FM modulated signal is specifically suitable in coded excitation ultrasound imaging.

In some embodiments, the system performs beamforming and reconstruction without assuming any specific structure of the pulse-compressed and beamformed signal. In other embodiments, the system exploits the structure of the pulse-compressed and beamformed signal, e.g., by using the fact that the pulse-compressed and beamformed signal is compressible, in a sense that it can be modeled efficiently, because the received coded signal comprises a small number of strong reflectors and much weaker speckle echoes. The structure of the pulse-compressed and beamformed signal can also be exploited using a suitable sparse representation over a suitable basis, e.g., using a wavelet representation. Reconstruction in these embodiments can be performed, for example, by using sparse recovery methods such as l1-norm optimization or various other recovery algorithms. The disclosed techniques perform pulse compression and beamforming in the frequency domain, and then perform recovery from either a partial or full bandwidth, either using linear operations based on inverse FFT and related weighting methods, or by using sparse recovery techniques or other regularized methods.

A major advantage of the disclosed techniques is the ability to perform combined pulse compression and beamforming in the frequency domain at low sampling and processing rates. When the full bandwidth of the pulse-compressed and beamformed signal is used, the proposed technique uses considerably lower sampling and processing rates than conventional time-domain processing, and provides equivalent imaging performance. Even when the sampling and processing rates are further reduced by using only partial bandwidth, the proposed technique is able to image both strong reflections and speckle echoes with high quality, which is highly important in various diagnostic applications. Example simulation results, which demonstrate the performance of the disclosed techniques, are given and discussed in U.S. Provisional Patent Application 62/441,464, cited above. The computation load in using the disclosed techniques is typically several orders of magnitude lower than comparable time domain implementations.

### System Description

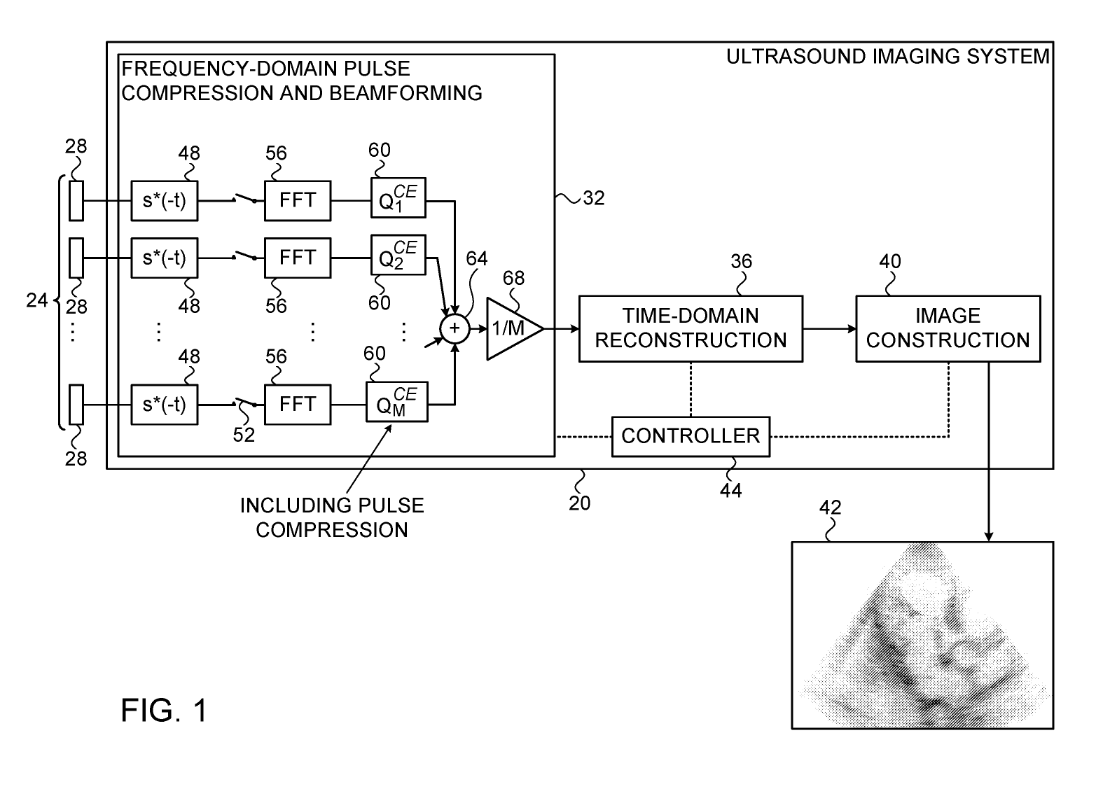

FIG. 1 is a block diagram that schematically illustrates an ultrasound imaging system 20, in accordance with an embodiment of the present invention. System 20 is typically used for producing ultrasound images of a target organ of a patient.

System 20 comprises an array 24 of ultrasound transducers 28, which are coupled to the patient body during imaging. The transducers transmit an ultrasonic signal into the tissue, and receive respective signals that comprise reflections (“echoes”) of the transmitted signal from the tissue. In the disclosed techniques the transmitted signal comprises a coded signal, as will be described below. The received signals are processed, using methods that are described herein, so as to reconstruct and display an ultrasound image 42 of the target organ.

In the embodiment of FIG. 1, system 20 comprises a frequency-domain beamforming unit 32, a time-domain reconstruction unit 36 and an image construction unit 40. A controller 44 controls the various system components. Beamforming unit 32 computes, for each transducer 28, a set of Fourier coefficients of the coded signal received by that transducer. These coefficients are referred to as transducer-specific Fourier coefficients. Unit 32 then combines the transducer-specific Fourier coefficients to produce a set of Fourier coefficients that represent a directional pulse-compressed and beamformed signal, which is produced from the multiple coded signals received by transducers 28. In combining the transducer-specific Fourier coefficients, unit 32 applies to the transducer-specific Fourier coefficients weights that (i) emphasize the reflections from a selected direction in the tissue relative to array 24, and (ii) implicitly apply pulse compression. The Fourier coefficients of the pulse-compressed and beamformed signal are referred to herein as beamforming Fourier coefficients.

Unit 32 derives the beamforming Fourier coefficients from the transducer-specific Fourier coefficients directly in the frequency domain. The beamforming Fourier coefficients are provided as input to time-domain reconstruction unit 36. Unit 36 reconstructs the beamformed signal for the selected direction from the beamforming Fourier coefficients.

The process of frequency-domain pulse compression and beamforming, and time-domain reconstruction, is typically repeated for multiple angular directions relative to array 24, e.g., over a desired angular sector. Image construction unit 40 constructs a graphical image of the tissue in the scanned sector, e.g., image 42 shown in the figure. The resulting image is provided as output, e.g., displayed to an operator and/or recorded.

In the present embodiment, beamforming unit 32 comprises multiple processing chains, a respective processing chain per each transducer 28. Each processing chain comprises a filter 48, a sampler 52, a Fast Fourier Transform (FFT) module 56 and a weighting module 60. The outputs of the processing chains are summed by an adder 64, and the sum is normalized by a gain module 68. (The configuration of the processing chains in unit 32 is an example configuration. In alternative embodiments, the processing chains may use other elements or configurations for computing the Fourier coefficients of the received coded signals.) The output of gain module 68 comprises the beamforming Fourier coefficients, i.e., the Fourier coefficients of the pulse-compressed and beamformed signal. The operation of beamforming unit 32 is described in detail below.

The system configuration of FIG. 1 is an example configuration, which is chosen purely for the sake of conceptual clarity. In alternative embodiments, any other suitable system configuration can be used. The elements of system 20 may be implemented using hardware. Digital elements can be implemented, for example, in one or more off-the-shelf devices, Application-Specific Integrated Circuits (ASICs) or FPGAs. Analog elements can be implemented, for example, using discrete components and/or one or more analog ICs. Some system elements may be implemented, additionally or alternatively, using software running on a suitable processor, e.g., a Digital Signal Processor (DSP). Some system elements may be implemented using a combination of hardware and software elements.

In some embodiments, some or all of the functions of system 20 may be implemented using a general-purpose computer, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

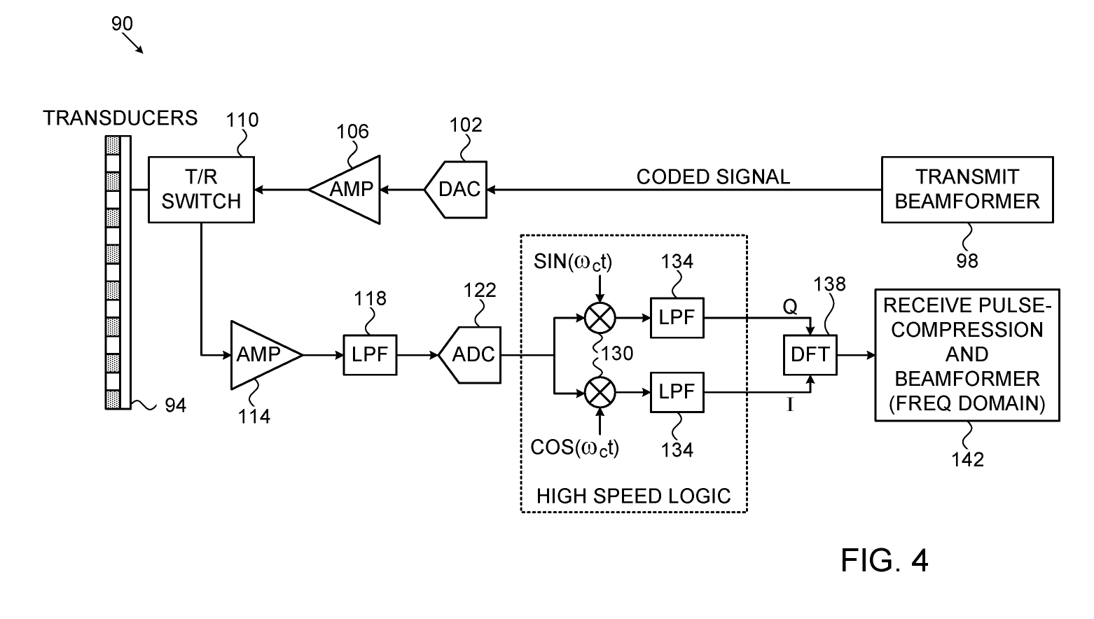

System elements that are not mandatory for understanding of the disclosed techniques, such as circuitry relating to transmission of the ultrasound coded signal, have been omitted from the figure for the sake of clarity. An alternative example implementation is described in FIG. 4 further below.

The various processing elements of system 20, e.g., beamforming unit 32, time-domain reconstruction unit 36 and image reconstruction unit 40, are sometimes referred to collectively as processing circuitry that carries out the disclosed techniques. Such processing circuitry typically operates in conjunction with a front end or other input interface that receives the coded signals from the ultrasound transducers. The front end (or input interface) is not shown in FIG. 1 for the sake of clarity, but is shown in FIG. 4 below.

The description that follows refers mainly to Fourier coefficients. Generally, however, the disclosed techniques can be carried out using coefficients of any suitable frequency-domain transform or signal representation, such as, for example, Fourier coefficients, Fast Fourier Transform (FFT) coefficients and Discrete Fourier Transform (DFT) coefficients. In the context of the present patent application and in the claims, all these types of coefficients are referred to as “frequency-domain coefficients.”

### Coded Excitation and Pulse Compression Principles

In some of the disclosed techniques, the transducers are excited using a coded signal comprising a modulated signal s(t) of the general form

s(t)=α(t)cos [2πf₀t+ψ(t)],0≤t≤Tₚ [1]

wherein ψ(t) and α(t) denote phase and amplitude functions, respectively. In Equation [1], f₀ denotes the central carrier frequency of s(t), and Tₚ denotes the duration of the transmitted pulse. Assuming the transmitted signal is reflected from L scatterers, the coded signal received by the transducer is given by

$$ϕ ( t ) = {\sum }_{l = 1}^{L} {α}_{l} s ( t - {t}_{l} ) \qquad [ 2 ]$$

wherein {αₗ}ₗ₌₁^{L} and {tₗ}ₗ₌₁^{L} denote amplitudes and delays corresponding to the reflectivity and locations of the respective scatterers. At the receive side, pulse compression can be performed (in the time domain) by applying to the received coded signal φ(t) a Matched Filter (MF) whose impulse response is given by h(t)=s*(−t). The signal produced by the MF, also referred to as an “MF output,” comprises a combination of L autocorrelation functions given by

$${ϕ}^{MF} ( t ) = ϕ ( t ) * {s}^{*} ( - t ) = {\sum }_{l = 1}^{L} {α}_{l} {R}_{ss} ( t - {t}_{l} ) \qquad [ 3 ]$$

wherein the autocorrelation function is given by

Rₛₛ(t)=∫_{-∞}^{∞}s(τ)s*(τ−t)dτ [4]

The pulse compression technique allows increasing the pulse duration (and therefore also the total amount of energy transmitted) without degrading imaging range resolution. The expected gain in SNR is approximately equal to the time-bandwidth product D=TₚB, wherein B is the bandwidth of the transmitted signal.

Equation [2] assumes that the reflected coded signals are attenuated replicas of the transmitted coded signal. In practice, however, the ultrasound signal propagates via biological tissue, causing a frequency-dependent attenuation. This attenuation can be modeled as replica-specific downshifts of the carrier frequency. The pulse reflected from the l^{th} scatterer is thus given by

s(t−tₗ,fₗ)=α(t−tₗ)cos[2π(f₀−fₗ)(t−tₗ)+ψ(t−tₗ)] [5]

Given an input coded signal as in Equation [5], the respective MF output can be modeled using a function denoted an “ambiguity function,” which is given by

A(t−tₗ,fₗ)=∫_{-∞}^{∞}s(τ−tₗ,fₗ)s*(τ−t)dτ [6]

In terms of the ambiguity function, the MF output is given (similarly to Equation [3]) by

$${ϕ}^{MF} ( t ) = ϕ ( t ) * {s}^{*} ( - t ) = {\sum }_{l = 1}^{L} {α}_{l} A ( t - {t}_{l} , {f}_{l} ) \qquad [ 7 ]$$

In ultrasound imaging, to achieve good axial resolution for all frequency shifts, the coded signal s(t) can be designed so that the ambiguity function has a narrow main lobe (in the time domain) for all values of fₗ. One possible coded signal having this property is a linear Frequency Modulation (FM) signal given by

$$s ( t ) = α ( t ) cos [ 2 π ( {f}_{0} - \frac{B}{2} ) t + \frac{B}{2 {T}_{p}} {t}^{2} ] , 0 \leq t \leq {T}_{p} \qquad [ 8 ]$$

Coded Excitation (CE) of a single-element transducer using linear FM is reported by Misaridis and Jensen, in “Use of modulated excitation signals in medical ultrasound. Part II: Design and performance for medical imaging applications,” IEEE Transactions on Ultrasonics, Ferroelectrics and Frequency Control, volume 52, number 2, 2005, pages 192-207. Embodiments for CE with beamforming using an array of transducers will be described below.

### Time-Domain Coded Excitation Beamforming

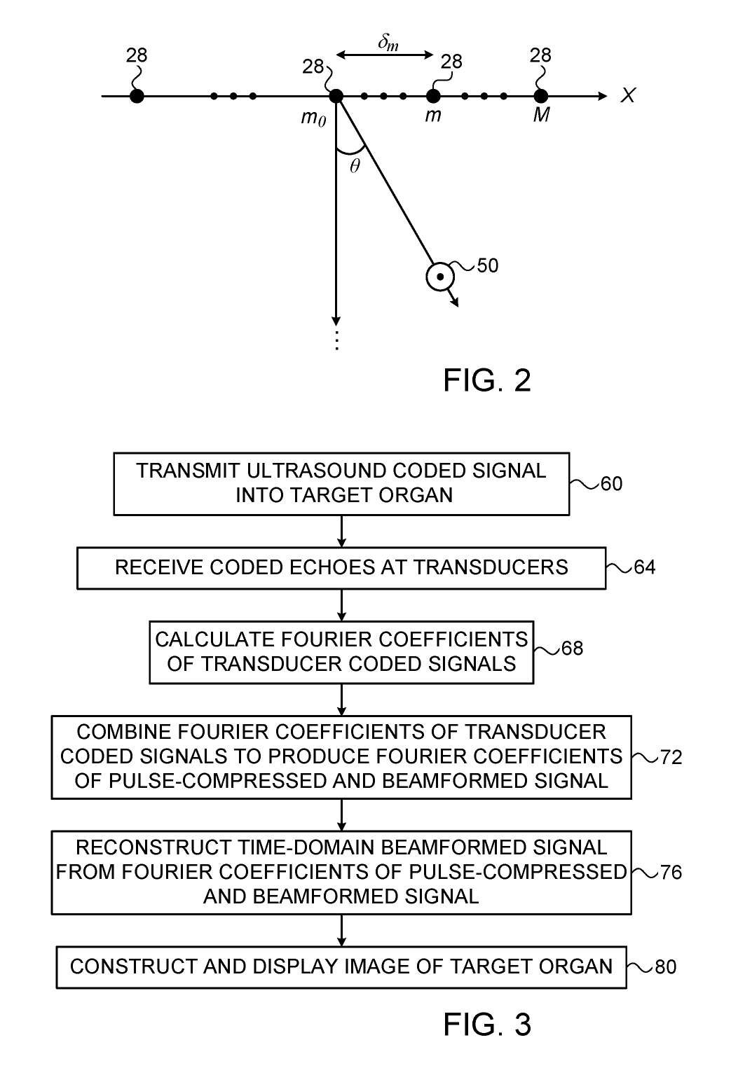

FIG. 2 is a diagram showing the geometry of array 24 of ultrasound transducers 28, in accordance with an embodiment of the present invention. The number of transducers in the array is denoted M, the transducers are assumed to lie in a linear array along the x axis with a reference element denoted m₀ at the origin. The model assumed herein is planar, with the perpendicular axis to the x axis denoted z. The distance between the m^{th} transducer and the origin is denoted δₘ. This array geometry is given purely by way of example. The disclosed techniques can be used with any other suitable array geometry, including, for example, two-dimensional transducer arrays used for three-dimensional imaging.

The imaging cycle for a particular angle θ begins at time t=0, at which the ultrasound signal is transmitted from the array to the tissue. In some embodiments, the transmitted signal comprises a coded signal. The signal is reflected from a point reflector 50 located at a certain distance from the array at direction θ. Reflector 50 scatters the signal, and the scattered echoes are eventually received by the M transducers 28 at times that depend on their distances from the reflector.

Let φₘ(t; θ) denote the signal received by the m^{th} transducer, and let \hat{τ}ₘ(t; θ) denote the time of reception of the echo at the m^{th} transducer. The beamforming operation involves applying appropriate time delays to the signals received by the different transducers, such that the echoes become time-aligned, and averaging the delayed signals. The time delays depend on the geometry of the array, on the direction θ, and on the distance to reflector 50 along direction θ.

The delayed, and thus time-aligned, signal of the m^{th} transducer is given by

\hat{φ}ₘ(m(t;θ)=φₘ(τₘ(t;θ)) [9]

τₘ(t;θ)=½(t+\sqrt{t²−4(δₘ/c)t·sin θ+4(δₘ/c)²} [10]

wherein c denotes the propagation velocity of the signal in the tissue. As noted above, to perform time-domain pulse compression, the coded signal received by each transducer is applied a suitable MF h(t) to produce the MF output signal φₘ^{MF}(t)={φₘ*h}(t). The pulse-compressed and beamformed signal derived from the multiple MF outputs is given by

$${Φ}_{CE} ( t ; θ ) = \frac{1}{M} {\sum }_{m = 1}^{M} {ϕ}_{m}^{MF} ( {τ}_{m} ( t ; θ ) ) \qquad [ 11 ]$$

It is important to note that by applying to the received coded signal the non-linear time-dependent delays as given in Equation [10], the pulse-compressed and beamformed signal in Equation [11] is both directed toward direction θ, and focused on the specific distance of reflector 50 from the array. This kind of beamforming (sometimes referred to as “dynamic focusing”) provides high Signal-to-Noise Ratio (SNR) and fine angular resolution, but on the other hand incurs heavy computational load and high sampling rate. The dynamic focusing beamforming scheme described above is typical of ultrasound applications, and is chosen purely by way of example. In alternative embodiments, the disclosed techniques can be used with any other suitable beamforming scheme.

Equation [11] above implies an implementation in which the coded signal received by each transducer is applied a separate MF. The complexity of such a scheme, however, is typically infeasible for array-based imaging. One approach to reduce complexity is to first calculate an uncompressed beamformed signal directly from the received coded signals, i.e., without applying the separate MFs, and then to apply the MF (i.e., pulse compression) to the uncompressed beamformed signal. Such post-compression beamforming, however, results in degraded performance, as reported, for example, by O'Donnell, in “Coded excitation system for improving the penetration of real-time phased-array imaging systems,” IEEE Transactions on Ultrasonics, Ferroelectrics and Frequency Control, volume 39, number 3, 1992, pages 341-351.

In the techniques disclosed herein, both pulse compression and beamforming are performed in the frequency domain with only modest complexity, as will be described in detail below.

### Frequency-Domain Combined Pulse Compression and Beamforming

In some embodiments, system 20 performs both pulse compression and beamforming operations in the frequency domain rather than in the time domain. As a result, sampling rate requirements and processing rates can be relaxed considerably. In some embodiments, implementing pulse compression in the frequency domain incurs no additional complexity over frequency-domain beamforming alone. The disclosed techniques allow exploiting spectral properties of the coded signal transmitted, to further reduce the rate.

The following description shows the relation between the Fourier coefficients of the individual coded signals received by the various transducers (denoted transducer-specific Fourier coefficients) and the Fourier coefficients of the pulse-compressed and beamformed signal (denoted beamforming Fourier coefficients). The description that follows refers to the specific beamforming scheme of Equations [9], [10] and [11]. The disclosed techniques are applicable in a similar manner to other forms of beamforming.

Let T be defined by the penetration depth of the tissue in question. T denotes the time it takes to the excitation signal to penetrate the tissue to a certain depth and return back to the transducer. The Fourier coefficients of Φ_{CE}(t; θ) with respect to interval [0, T) are given by

$${c}_{CE}^{s} [ k ] = \frac{1}{M} {\sum }_{m = 1}^{M} {c}_{m}^{s , CE} [ k ] \qquad [ 12 ]$$

wherein cₘ^{s,CE}[k] are defined as

$$\begin{matrix} {c}_{m}^{s , CE} [ k ] = \frac{1}{T} {\int }_{0}^{T} {g}_{k , m} ( t ; θ ) {ϕ}_{m}^{MF} ( t ) dt & [ 13 ] \\ with {g}_{k , m} ( t ; θ ) = {q}_{k , m} ( t ; θ ) {e}^{- i \frac{2 π}{T} kt} , & [ 14 ] \\ {g}_{k , m} ( t ; θ ) = {I}_{[ \vert {γ}_{m} \vert , {τ}_{m} ( T ; θ ) )} ( t ) ( 1 + \frac{{γ}_{m}^{2} cos {θ}^{2}}{{( t - {γ}_{m} sin θ )}^{2}} ) \times exp \{ i \frac{2 π}{t} k \frac{{γ}_{m} - t sin θ}{t - {γ}_{m} sin θ} {γ}_{m} \} {γ}_{m} = {δ}_{m} / c & [ 15 ]\end{matrix}$$

wherein in Equation [15] I_{[a,b)} denotes an indicator function that is equal to unity for a≤t<b and zero otherwise. Replacing φₘ^{MF}(t) by its Fourier coefficients cₘ^{s,MF}[n] Equation [13] can be written as

$$\begin{matrix}{c}_{m}^{s , CE} [ k ] = {\sum }_{n} {c}_{m}^{s , MF} [ n ] \frac{1}{T} {\int }_{0}^{T} {q}_{k , m} ( t ; θ ) {e}^{- i \frac{2 π}{T} ( k - n ) t} dt \\ = {\sum }_{n} {c}_{m}^{s , MF} [ k - n ] {Q}_{k , m , θ} [ n ]\end{matrix} \qquad [ 16 ]$$

wherein Q_{k,m,θ}[n] are the Fourier coefficients of the distortion function q_{k,m}(t; θ) with respect to [0, T).

Equations [12]-[16] above essentially recite the same calculation process as Equations [13]-[16] of U.S. Provisional Patent Application 62/441,464 cited above. In the provisional application frequency-domain beamforming was first introduced without cₘ^{s,MF} for the sake of clarity. Based on the on the convolution theorem, the Fourier coefficients cₘ^{s,MF} are given by cₘ^{s}[n]h[n], wherein cₘ^{s}[n] and h[n] denote the Fourier coefficients of the received signal φₘ(t) and the impulse response h(t) of the MF of the transmitted coded signal, respectively. Equation [16] can therefore be written as:

$${c}_{m}^{s , CE} [ k ] = {\sum }_{n} {c}_{m}^{s} [ k - n ] {Q}_{k , m , θ}^{CE} [ n ] \\ {Q}_{k , m , θ}^{CE} [ n ] = h ( k - n ) {Q}_{k , m , θ} [ n ] \qquad [ 17 ]$$

In practice, cₘ^{s}[k] can be well approximated by replacing the infinite sum in Equation [17] with a finite sum:

$${c}_{m}^{s , CE} [ k ] ≅ {\sum }_{n ∈ v ( k )} {c}_{m}^{s} [ k - n ] {Q}_{k , m , θ}^{CE} [ n ] \qquad [ 18 ]$$

The set v(k) depends on the decay properties of {Q_{k,m,θ}^{CE}[n]}. Numerical analysis of this function shows that most of the energy of the set {Q_{k,m,θ}^{CE}[n]} (similarly to the set {Q_{k,m,θ}^{CE}[n]}) is concentrated around the DC component (for any k, m and θ), and therefore it makes sense to select v(k)={−N₁, . . . , N₂}:

$${c}_{m}^{s , CE} [ k ] ≅ {\sum }_{n = - {N}_{1}}^{{N}_{2}} {c}_{m}^{s} [ k - n ] {Q}_{k , m , θ}^{CE} [ n ] \qquad [ 19 ]$$

By substituting Equation [19] into [12] the Fourier coefficients of the pulse-compressed and beamformed signal are given by

$${c}_{CE}^{s} [ k ] ≅ \frac{1}{M} {\sum }_{m = 1}^{M} {\sum }_{n = - {N}_{1}}^{{N}_{2}} {c}_{m}^{s} [ k - n ] {Q}_{k , m , θ}^{CE} [ n ] \qquad [ 20 ]$$

Equations [19] and [20] above essentially recite the same calculation process as Equations [21] and [22] of U.S. Provisional Patent Application 62/441,464 cited above, respectively.

In most practical cases, taking the finite sum in Equation [19] over the twenty most significant elements in {Q_{k,m,θ}^{CE}[n]} provides a sufficiently-accurate approximation. Alternatively, however, other finite ranges and/or other approximations can also be used.

Let γ, |γ|=G denote the set of Fourier coefficients corresponding to the actual bandwidth of the m^{th} MF output φₘ^{MF}(t), i.e., the values of k for which cₘ^{s,MF}[k] is non-zero or at least larger than a threshold. The set γ typically correspond to the effective Nyquist pass-band bandwidth of the coded signals. In addition, the received coded signal and the MF output have essentially the same bandwidth. It follows that the bandwidth γ_{BF} of the pulse-compressed and beamformed signal contains no more than G+N_{q} non-zero frequency components, wherein N_{q}=N1+N₂+1 denotes the number of Q_{k,m,θ}^{CE} coefficients used in the approximation in Equations [19] and [20].

Computing the elements of γ_{BF} requires the set γ for each of the received coded signals filtered by the MF, i.e., the pulse-compressed versions of the received coded signals. In a typical imaging scenario, G is on the order of several hundreds of coefficients, whereas N_{q} is on the order of tens. These orders of magnitude imply that G»N_{q}, and thus G+N_{q}≈G. Therefore, the bandwidth of the pulsed-compressed and beamformed signal is approximately the same as the bandwidth of the MF outputs derived from the received coded signals.

According to Equation [20], computing a number K of Fourier coefficients c_{CE}[k] involves at most K+N_{q} Fourier coefficients cₘ^{s}[n] corresponding to the individual received signals. These coefficients can be obtained from K+N_{q} point-wise samples (in the time domain) of the received coded signal filtered using a suitable analog kernel s*(−t). In ultrasound imaging in which a coded signal (modulated pulse) uses for excitation, the pulse energy is concentrated mostly in a frequency band that is not zero-centered. As a result, the analog kernel can be implemented as a band-pass filter, leading to a low-rate sampling scheme. A low-rate sampling scheme of this sort is described in U.S. Pat. No. 9,778,557, cited above.

Another result is that in order to calculate an arbitrary subset μ⊂γ_{BF} of size K of beamforming Fourier coefficients, no more than K+N_{q} transducer-specific Fourier coefficients are needed for each of the received signals φₘ(t). A sampling scheme for using the subset subset μ⊂γ_{BF} is also referred to as a sub-Nyquist sampling scheme. These properties of frequency-domain beamforming combined with pulse compression can be used for sampling rate reduction, as will be shown below.

Equations [12] and [19] above define the relationship between the beamforming Fourier coefficients (the Fourier series coefficients of the pulse-compressed and beamformed signal) and the transducer-specific Fourier coefficients (the Fourier series coefficients of the individual signals received by transducers 28).

A similar relationship can be defined between the DFT coefficients of these signals, sampled at the beamforming rate fₛ. Let N=└T·fₛ┘ denote the resulting number of samples of the pulse-compressed and beamformed signal. Since in ultrasound imaging fₛ is typically higher than the Nyquist rate of the received signals, the relation between the DFT of length N and the Fourier series coefficients of φₘ(t) is given by

$${c}_{m}^{s} [ n ] = \frac{1}{N} \{ \begin{matrix}{ϕ}_{m} [ n ] , & 0 \leq n \leq P \\ {ϕ}_{m} [ N + n ] , & - P \leq n < o \\ 0 , & otherwise\end{matrix} \qquad [ 21 ]$$

wherein φₘ[n] denotes the DFT coefficients and P denotes the index of the Fourier transform coefficient corresponding to the highest frequency component.

Equation [21] can be used for substituting Fourier series coefficients cₘ^{s}[n] of φₘ(t) in Equation [19] with DFT coefficients φₘ[n] of its sampled version. Substituting this result into Equation [12] yields a relationship between the Fourier series coefficients of the pulse-compressed and beamformed signal and the DFT coefficients of the sampled received signals:

$${c}_{CE}^{s} [ k ] ≅ \frac{1}{MN} {\sum }_{m = 1}^{M} {\sum }_{n = - {N}_{1}}^{k - \tilde{n}} {ϕ}_{m} [ k - n ] {Q}_{k , m , θ}^{CE} [ n ] + {\sum }_{n = k - \tilde{n} + 1}^{{N}_{2}} {ϕ}_{m} [ k - n + N ] {Q}_{k , m , θ}^{CE} [ n ] \qquad [ 22 ]$$

for a properly chosen ñ. Since fₛ is higher than the Nyquist rate of the beamformed signal, as well, the DFT coefficients c_{CE}[k] of its sampled version are given by a relationship similar to Equation [21]:

$${c}_{CE} [ k ] = N \{ \begin{matrix}{c}_{CE}^{s} [ k ] , & 0 \leq k \leq P \\ {c}_{CE}^{s} [ k - N ] , & N - P \leq k < N \\ 0 , & otherwise\end{matrix} \qquad [ 23 ]$$

Equations [22] and [23] thus define the relationship between the DFT coefficients of the pulse-compressed and beamformed signal and the DFT coefficients of the received signals. As noted above, the above relationship refers to one particular beamforming scheme, which is chosen by way of example. The disclosed techniques are applicable in a similar manner to other forms of beamforming.

This relationship, which is obtained by periodic shift and scaling of Equation [19], retains the properties of the latter. Applying Inverse DFT (IDFT) to the sequence {c_{CE}[k]}ₖ₌₀^{N-1} reconstructs the beamformed signal in the time domain. Reconstruction of the image can be performed by applying image generation operation such as, for example, log-compression and interpolation.

FIG. 3 is a flow chart that schematically illustrates a method for ultrasound imaging, performed by system 20 of FIG. 1 above, in accordance with an embodiment of the present invention. The method begins with system 20 transmitting an ultrasound signal into the tissue in question, at a transmission step 60. The signal transmitted at step 60 comprises a coded signal, e.g., a signal modulated using linear FM scheme as given in Equation [8] above. Transducers 28 receive the reflected echoes of the coded signal, at a reception step 64. Referring to the configuration of FIG. 1, the M processing chains of beamforming unit 32 receive the respective received signals {φₘ(t))ₘ₌₁^{M}.

Unit 32 computes the transducer-specific Fourier coefficients of the received coded signals, at a transducer-specific calculation step 68. In the m^{th} processing chain, filter 48 filters the received coded signal φₘ(t) with a suitable kernel s*(−t). (Filtering with a kernel is one possible example implementation. Kernel filter 48 is not to be confused with the MF corresponding to the transmitted coded signal and applied in the frequency domain. In alternative embodiments, other suitable analog means can be used, or the input coded signal can first be sampled and then its rate is reduced digitally.)

Sampler 52 digitizes the filtered version of the received coded signal at a low sampling rate, which is defined by the effective bandwidth of the transmitted coded signal, typically corresponding to the Nyquist rate with respect to the effective bandwidth of the transmitted coded signal. (When exploiting the coded signal structure, as will be explained below, only a portion of the coded signal bandwidth is needed and the sampling rate can be reduced below the Nyquist rate.) Note that the coded signal and the MF output signal have essentially the same bandwidth, because convolving the impulse response of the MF with the coded signal translates to a squaring operation in the frequency domain, which affects the amplitude but preserves the bandwidth.

In an embodiment, FFT module 56 computes the DFT coefficients of the digitized coded signal, to produce φₘ[n]. Weighting module 60 applies weighting with the appropriate elements of {Q_{k,m,θ}^{CE}[n]}, which implicitly contain the MF coefficients h[n] for performing pulse compression in the frequency domain. This process is performed in a similar manner in all M processing chains. Alternatively, unit 32 may use any other suitable process to obtain the Fourier coefficients of the coded signal over the desired bandwidth. The processing and/or sampling rate are affected by this bandwidth only.

Adder 64 of unit 32 sums the weighted transducer-specific Fourier coefficients from the M processing chains, at a combining step 72. The sum is normalized using gain module 68, to produce the beamforming Fourier coefficients of the pulse-compressed and beamformed signal. The output of unit 32 is thus {c_{CE}[k]}ₖ₌₀^{N-1}.

At a time-domain reconstruction step 76, time-domain reconstruction unit 36 reconstructs the time-domain beamformed signal by applying IDFT to {c_{CE}[k]}ₖ₌₀^{N-1}. Alternatively, when signal structure is taken into consideration (e.g., as in coded excitation), methods that exploit this structure (e.g., sparse recovery or regularized techniques) can be used, thereby allowing the use of a smaller number of Fourier coefficients. The process of steps 60-76 is typically repeated over multiple values of θ, e.g., by scanning a desired angular sector relative to array 24. At an image construction step 80, image construction unit 40 constructs and outputs an image of the target organ from the time-domain beamformed signals obtained for the different values of θ.

Example simulation results, which demonstrate the performance of the above-described process, are given and discussed in U.S. Provisional Patent Application 62/441,464, cited above.

### Sampling Rate Reduction

Performing the beamforming and pulse compression operations in the frequency domain enables system 20 to sample the coded signals received by transducers 28 with a low sampling rate, while still providing high imaging quality.

As explained above, the bandwidth γ_{BF} of the pulse-compressed and beamformed signal contains approximately G non-zero frequency components. In some embodiments, unit 32 exploits this property and calculates, for each received coded signal, the DFT coefficients only for the G non-zero frequency components in γ_{BF}.

The ratio between the cardinality of the set γ (the set of Fourier coefficients corresponding to the bandwidth at the MF output) and the overall number of samples N needed by the conventional beamforming rate fₛ, depends on the over-sampling factor. The beamforming rate fₛ is often defined as four to ten times the pass-band bandwidth of the received coded signals, meaning G/N is on the order of 0.1-0.25. Assuming it is possible to obtain the set γ using G low-rate samples of each received signal, this ratio implies a potential four- to ten-fold reduction in sampling rate relative to time-domain beamforming.

In some embodiments, unit 32 samples the received coded signals using such a low sampling rate so as to obtain the appropriate non-zero Fourier coefficients. Example sub-Nyquist sampling schemes that can be used for this purpose are described, for example, in the paper “Innovation Rate Sampling of Pulse Streams with Application to Ultrasound Imaging” by Tur et al., in the paper “Compressed Beamforming in Ultrasound Imaging” by Wagner et al., both cited above and incorporated herein by reference, as well as in U.S. Patent Application Publications 2011/0225218 and 2013/0038479, which are both assigned to the assignee of the present patent application and whose disclosures are incorporated herein by reference.

Other suitable sub-Nyquist sampling schemes that can be used by unit 32 are described by Gedalyahu et al., in “Multichannel Sampling of Pulse Streams at the Rate of Innovation,” IEEE Transactions on Signal Processing, volume 59, number 4, pages 1491-1504, 2011, which is incorporated herein by reference. Example hardware that can be used for this purpose is described by Baransky et al., in “A Sub-Nyquist Radar Prototype: Hardware and Algorithms,” IEEE Transactions on Aerospace and Electronic Systems, volume 50, issue 2, April, 2014, pages 809-822, which is incorporated herein by reference.

In a Nyquist sampling scheme (using all of the Fourier coefficients in γ at the MF output) or a sub-Nyquist sampling scheme (using Fourier coefficients in a sub-band of γ), which is implemented by unit 32 in FIG. 1, each received coded signal is filtered by the respective filter 48 with a kernel s*(−t). Note that using filter 48 is not mandatory and other suitable methods, e.g., integrating the received coded signal, can also be used. The kernel is defined based on the bandwidth of the transmitted ultrasound coded signal and the set γ. After obtaining the set γ for each of the received signals (i.e., in each of the processing chains of unit 32), unit 32 calculates the elements of γ_{BF} using low-rate frequency-domain beamforming and pulse compression as described above.

Reconstruction unit 36 then applies IDFT to the output of unit 32, so as to reconstruct the time-domain beamformed signal. In some embodiments, unit 36 pads the elements of γ_{BF} with zeros prior to performing IDFT, in order to improve time resolution. In an example implementation intended for comparison with time-domain beamforming, unit 36 pads the elements of γ_{BF} with N−G zeros. Alternatively, however, any other suitable padding ratio can be used.

In addition to reduction in sampling rate, the above technique reduces the amount of noise in the sampled signal, since conventional time-domain sampling captures noise in the entire frequency spectrum up to the signal frequency and not only within the actual signal bandwidth. Moreover, the above technique reduces processing rates. The effect of this technique on imaging quality is demonstrated in U.S. Provisional Patent Application 62/441,464, cited above.

In some embodiments, unit 32 of system 20 achieves an additional reduction in sampling rate by computing only a partial subset of the non-zero DFT coefficients of the received signals. The sampling performed by such embodiments is referred to herein as “sub-Nyquist sampling.” The subset is denoted μ, μ⊂γ_{BF}, |μ|=M1<G_{BF}=|γ_{BF}|. In this embodiment, unit 32 computes only M1 frequency components for each received signal, i.e., only M1 samples per processing channel.

When computing only the partial subset μ, in some embodiments unit 36 reconstructs the beamformed signal using Compressed Sensing (CS) techniques, sparse recovery methods or more general regularized or greedy methods. CS-based reconstruction can typically be used when the signal structure is exploited. For example, in some cases it can be assumed that the received coded signals are sparse (in the time domain) and thus the pulse-compressed and beamformed signal Φ_{CE}(t; θ) can be regarded as sparse in a suitable basis, or having a Finite Rate of Innovation (FRI). Under this assumption, the pulse-compressed and beamformed signal can be modeled as a sum of cross-sections of the ambiguity function A (t, f) with unknown amplitudes and delays. The pulse-compressed and beamformed signal can thus be written as:

$${Φ}_{CE} [ t ; θ ] ≅ {\sum }_{l = 1}^{L} {α}_{l} A ( t - {t}_{l} , {f}_{l} ) \qquad [ 24 ]$$

wherein L denotes the number of scattering elements (reflecting objects) in direction θ, {αₗ}ₗ₌₁^{L} denotes the unknown amplitudes of the reflections, and {tₗ}ₗ₌₁^{L} denotes the arrival times (delays) of the reflections at the reference transducer m₀. When the coded signal comprises a linear FM signal, the ambiguity function is essentially constant over all frequency shifts {fₗ}ₗ₌₁^{L} and therefore fₗ can be omitted. Since the ambiguity function is known, the pulse-compressed and beamformed signal is defined in full by the 2L unknown parameters (L amplitudes and L delays).

The model of Equation [24] can be rewritten in discrete form, after sampling the equation at the beamforming rate fₛ and quantizing the delays with a quantization step of 1/fₛ, to give:

$${Φ}_{CE} [ n ; θ ] ≅ {\sum }_{l = 1}^{L} {α}_{l} A ( t - {q}_{l} ) = {\sum }_{l = 0}^{N - 1} {b}_{l} A ( n - l ) \qquad [ 25 ]$$

wherein tₗ=qₗ/fₛ, N=└T·fₛ┘, and

$${b}_{l} = \{ \begin{matrix}{α}_{l} & l = {q}_{l} \\ 0 & otherwise\end{matrix} \qquad [ 26 ]$$

Calculating the DFT of both sides of Equation [25] yields the following expression for the DFT coefficients of the pulse-compressed and beamformed signal:

$${c}_{CE} [ k ] = a [ k ] {\sum }_{l = 0}^{N - 1} {b}_{l} {e}^{- i \frac{2 π}{N} kl} \qquad [ 27 ]$$

wherein a[k] denotes the k^{th} DFT coefficient of the ambiguity function, the transmitted pulse sampled at rate fₛ. With this notation, recovering Φ_{CE}[n; θ] is equivalent to determining {bₗ}ₗ₌₀^{N-1} in Equation [27].

Equivalently, in vector-matrix notation, let c_{CE} denote a measurement vector of length M1 whose k^{th} element is c_{CE}[k], k∈μ. Equation [27] can be written as:

c_{CE}=HDb=Ab [28]

wherein H is an M1-by-M1 diagonal matrix whose k^{th} diagonal element is a[k], D is an M1-by-N matrix formed by taking the set μ of rows from an N-by-N DFT matrix, and b is a vector of length N whose l^{th} element is bₗ. The recovery operation is thus equivalent to determining vector b from vector c_{CE}.

In some embodiments, reconstruction unit 36 of system 20 determines b by solving the optimization problem:

min_{b}∥b∥₁ subject to ∥Ab−c_{CE}∥₂≤ε [29]

wherein ∥ ∥₁ denotes l₁ norm (sum of absolute values) and ∥ ∥₂ denotes l2 norm (Root Mean Square—RMS).

This optimization problem of Equation [29] assumes that the received coded signals comprise a relatively small number of strong reflectors, plus multiple additional scattered echoes that are typically two orders of magnitude weaker. In other words, vector b is compressible, i.e., approximately but not entirely sparse. This signal model is highly descriptive of ultrasound reflections from tissue, which comprise strong reflections plus a considerable amount of speckle. This property of b is well captured by the l1 norm in Equation [29]. The l1-norm optimization of Equation [29] is one example of a recovery scheme that assumes that the signal is compressible, but not necessarily sparse. In alternative embodiments, any other recovery method that operates under a constraint that the signal is compressible can be used. Further alternatively, methods that exploit the FRI structure of the pulse-compressed and beamformed signal or compressibility properties of this signal in other domains can also be used.

Alternatively to the optimization of Equation [29], various other sparse recovery methods can be used, including methods based on l0-norm or other sparse-based techniques. Further alternatively, instead of using sparse recovery methods, unit 36 may use various techniques for recovery of sinusoids from a sum-of-sinusoids. Example methods include MUSIC, ESPRIT, Capon beamforming, among others. Any such technique can be used by unit 36 to solve Equation [27], and do not require sparsity assumptions. Instead, these techniques exploit the structure in the signal.

In various embodiments, unit 36 may solve the optimization problem of Equation [29] in any suitable way. Example optimization schemes that can be used for this purpose are second-order methods such as interior-point methods described by Candes and Romberg, in “l1-magic: Recovery of Sparse Signals via Convex Programming,” October, 2005; and by Grant and Boyd, in “The CVX User's Guide,” CVX Research, Inc., November, 2013, which are incorporated herein by reference.

Other example optimization schemes that can be used by unit 36 are first-order methods based on iterative shrinkage, as described by Beck and Teboulle, in “A Fast Iterative Shrinkage-Thresholding Algorithm for Linear Inverse Problems,” SIAM Journal on Imaging Sciences, volume 2, number 1, 2009, pages 183-202; and by Hale et al., in “A Fixed-Point Continuation Method for l1-Regularized Minimization with Application to Compressed Sensing,” CAAM Technical Report TR07-07, Rice University, Jul. 7, 2007, which are incorporated herein by reference.

Solving for b in an l1-norm optimization provides high quality imaging, since it accounts well for both strong reflectors and speckle. Information conveyed by speckle is of high importance in many ultrasound imaging procedures. Example images that demonstrate this quality are provided in U.S. Provisional Patent Application 62/441,464, cited above.

### Alternative System Implementation

FIG. 4 is a block diagram that schematically illustrates an ultrasound imaging system 90, in accordance with an alternative embodiment of the present invention. System 90 comprises an array 94 of ultrasound transducers that are used both for beamformed transmission and for beamformed reception. For the sake of clarity, the figure shows a single transmission path and a single reception path. In practice, the system comprises a respective transmission path and a respective reception path per transducer.

On transmission, a transmit beamformer 98 generates a beamformed set of digital coded signals for transmission. A set of Digital to Analog Converters (DACs) 102 convert the digital signals into analog ultrasound signals. A set of amplifiers 106 amplify the ultrasound signals, and the coded signals are fed via respective Transmit/Receive (T/R) switches 110 to array 94.

On reception, the received ultrasound coded signals from the transducers pass through T/R switches 110 and amplified by respective amplifiers 114. A set of Low-Pass Filters (LPFs) 118 filter the received coded signals, and the filtered signals are sampled (digitized) using respective Analog to Digital Converters (ADCs) 122.

The digital circuitry of system 90 comprises high-speed logic that processes the digitized received signal. For each received signal, the high-speed logic comprises a Quadrature down-converter 130 followed by a pair of LPFs 134. The complex (I/Q) baseband signal produced by the down-converter is provided to a DFT module 138, which computes DFT coefficients of the received coded signal. A frequency-domain receive pulse-compression and beamforming unit 142 recovers the pulse-compressed and beamformed signal from the DFT coefficients of the multiple received coded signals, using the frequency-domain pulse compression and beamforming methods described herein.

The system configuration of FIG. 4 is depicted purely by way of example. In alternative embodiments, any other suitable system configuration can also be used. In the present context, elements 110, 114, 118, 122, 130 and 134 serve as an input interface that receives the ultrasound reflections, and elements 138 and 142 serve as processing circuitry that computes the transducer-specific frequency-domain coefficients for each of the received signals, derives beamforming frequency-domain coefficients of the pulse-compressed and beamformed signal directly from the transducer-specific frequency-domain coefficients, and reconstructs the ultrasound image of the target organ based on the beamforming frequency-domain coefficients.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
receiving from multiple transducers respective signals comprising reflections of a transmitted coded signal from a target; and
producing an image of the target, by:
computing transducer-specific frequency-domain coefficients for each of the received signals;
deriving, from the transducer-specific frequency-domain coefficients, beamforming frequency-domain coefficients of a beamformed signal in which (i) the reflections are applied pulse compression, and (ii) the reflections received from a selected direction relative to the transducers are emphasized; and
reconstructing the image of the target at the selected direction based on the beamforming frequency-domain coefficients.

2. The method according to claim 1, wherein the transmitted coded signal comprises a signal modulated using a linear Frequency Modulation (FM) scheme.

3. The method according to claim 1, wherein deriving the beamforming frequency-domain coefficients comprises computing the beamforming frequency-domain coefficients only within an effective bandwidth of the beamformed signal.

4. The method according to claim 1, wherein reconstructing the image comprises applying an inverse Fourier transform to the beamforming frequency-domain coefficients.

5. The method according to claim 1, wherein deriving the beamforming frequency-domain coefficients comprises computing the beamforming frequency-domain coefficients only within a partial sub-band within an effective bandwidth of the beamformed signal.

6. The method according to claim 1, wherein reconstructing the image comprises applying to the beamformed frequency-domain coefficients a recovery process selected from a list comprising (i) a Compressed Sensing (CS) process, (ii) a sparse recovery process, and (iii) a regularized recovery process.

7. The method according to claim 1, wherein reconstructing the image comprises applying to the beamformed frequency-domain coefficients an algorithm for extracting sinusoids from a sum of sinusoids.

8. The method according to claim 1, wherein reconstructing the image comprises estimating the beamformed signal in time-domain based on the beamforming frequency-domain coefficients, and reconstructing the image from the estimated beamformed signal.

9. The method according to claim 8, wherein estimating the beamformed signal comprises applying an l1-norm optimization to the beamforming frequency-domain coefficients.

10. The method according to claim 1, wherein deriving the beamforming frequency-domain coefficients comprises computing a weighted average of the transducer-specific frequency-domain coefficients.

11. The method according to claim 10, wherein computing the weighted average comprises applying to the transducer-specific frequency-domain coefficients predefined weights that depend on the transmitted coded signal.

12. The method according to claim 1, wherein reconstructing the image of the target comprises reconstructing both dominant reflections and speckle based on the beamforming frequency-domain coefficients.

13. The method according to claim 1, wherein computing the transducer-specific frequency-domain coefficients comprises deriving the transducer-specific frequency-domain coefficients from sub-Nyquist samples of the received signals.

14. Apparatus, comprising:
an input interface, which is configured to receive from multiple transducers respective signals comprising reflections of a transmitted coded signal from a target; and
processing circuitry, which is configured to produce an image of the target, by computing transducer-specific frequency-domain coefficients for each of the received signals, deriving, from the transducer-specific frequency-domain coefficients, beamforming frequency-domain coefficients of a beamformed signal in which (i) the reflections are applied pulse compression, and (ii) the reflections received from a selected direction relative to the transducers are emphasized, and reconstructing the image of the target at the selected direction based on the beamforming frequency-domain coefficients.

15. The apparatus according to claim 14, wherein the transmitted coded signal comprises a signal modulated using a linear Frequency Modulation (FM) scheme.

16. The apparatus according to claim 14, wherein the processing circuitry is configured to compute the beamforming frequency-domain coefficients only within an effective bandwidth of the beamformed signal.

17. The apparatus according to claim 14, wherein the processing circuitry is configured to reconstruct the image by applying an inverse Fourier transform to the beamforming frequency-domain coefficients.

18. The apparatus according to claim 14, wherein the processing circuitry is configured to compute the beamforming frequency-domain coefficients only within a partial sub-band within an effective bandwidth of the beamformed signal.

19. The apparatus according to claim 14, wherein the processing circuitry is configured to reconstruct the image by applying to the beamformed frequency-domain coefficients a recovery process selected from a list comprising (i) a Compressed Sensing (CS), (ii) a sparse recovery process, and (iii) a regularized recovery process.

20. The apparatus according to claim 14, wherein the processing circuitry is configured to reconstruct the image by applying to the beamformed frequency-domain coefficients an algorithm for extracting sinusoids from a sum of sinusoids.

21. The apparatus according to claim 14, wherein the processing circuitry is configured to estimate the beamformed signal in time-domain based on the beamforming frequency-domain coefficients, and to reconstruct the image from the estimated beamformed signal.

22. The apparatus according to claim 21, wherein the processing circuitry is configured to estimate the beamformed signal by applying an l1-norm optimization to the beamforming frequency-domain coefficients.

23. The apparatus according to claim 14, wherein the processing circuitry is configured to derive the beamforming frequency-domain coefficients by computing a weighted average of the transducer-specific frequency-domain coefficients.

24. The apparatus according to claim 23, wherein the processing circuitry is configured to compute the weighted average by applying to the transducer-specific frequency-domain coefficients predefined weights that depend on the transmitted coded signal.

25. The apparatus according to claim 14, wherein the processing circuitry is configured to reconstruct both dominant reflections and speckle based on the beamforming frequency-domain coefficients.

26. The apparatus according to claim 14, wherein the processing circuitry is configured to derive the transducer-specific frequency-domain coefficients from sub-Nyquist samples of the received signals.

27. A method, comprising:
receiving from multiple transducers respective signals comprising reflections of a transmitted coded signal from a target;
computing transducer-specific frequency-domain coefficients for each of the received signals;
deriving, from the transducer-specific frequency-domain coefficients, beamforming frequency-domain coefficients of a beamformed signal in which (i) the reflections are applied pulse compression, and (ii) the reflections received from a selected direction relative to the transducers are emphasized; and
reconstructing an image of the target at the selected direction based on the beamforming frequency-domain coefficients, under a constraint that the received signals are compressible.

28. The method according to claim 27, wherein the transmitted coded signal comprises a signal modulated using a linear Frequency Modulation (FM) scheme.

29. The method according to claim 27, wherein reconstructing the image comprises applying an l1-norm optimization to the beamforming frequency-domain coefficients.

30. Apparatus, comprising:
an input interface, which is configured to receive from multiple transducers respective signals comprising reflections of a transmitted coded signal from a target; and
processing circuitry, which is configured to compute transducer-specific frequency-domain coefficients for each of the received signals, to derive, from the transducer-specific frequency-domain coefficients, beamforming frequency-domain coefficients of a beamformed signal in which (i) the reflections are applied pulse compression, and (ii) the reflections received from a selected direction relative to the transducers are emphasized, and to reconstruct an image of the target at the selected direction based on the beamforming frequency-domain coefficients, under a constraint that the received signals are compressible.

31. The apparatus according to claim 30, wherein the transmitted coded signal comprises a signal modulated using a linear Frequency Modulation (FM) scheme.

32. The apparatus according to claim 30, wherein the processing circuitry is configured to reconstruct the image by applying an l1-norm optimization to the beamforming frequency-domain coefficients.
